(19) United States
(12) Patent Application Publication
(10) Pub. No.: US 2009/0236444 A1
(43) Pub. Date: Sep. 24, 2009

(54) SANITARY SYSTEM COMPRISING A HAND-HELD SHOWER AND A CHARGING SET

(75) Inventors: Horst Kunkel, Stuttgart (DE); Gunter Veigel, Leonberg (DE)

Correspondence Address: FACTOR & LAKE, LTD, 1327 W. WASHINGTON BLVD., SUITE 5G/H, CHICAGO, IL, 60607, US

(73) Assignee: HANSA METALLWERKE AG, Stuttgart (DE)

(21) Appl. No.: 12/299,697

(22) PCT Filed: Apr. 28, 2007
(86) PCT No.: PCT/EP2007/003794

§ 371 Date: Apr. 29, 2009

(30) Foreign Application Priority Data
May 10, 2006 (DE) 10 2006 021 697.0

(51) Int. Cl. B05B 15/00; A47K 3/00

(52) U.S. Cl. 239/289; 4/615

(57) ABSTRACT

The invention relates to a sanitary system with a hand-held shower including a handle which can be connected to a shower hose and carries a shower head, and at least one lighting device arranged in the shower head. Said lighting device can be supplied with power by at least one accumulator which is connected to connections in a manner accessible from the exterior for connection to a charging set. The sanitary system further including a charging set for charging the accumulator. The accumulator is accommodated in the shower head which, in a coupling area, has the connections for connecting the accumulator to the charging set. The shower head can be detached from the handle and the charging set includes an accommodating area into which the shower head can be introduced with its coupling area for charging the accumulator and which has an inner contour that is complementary to the outer contour of the coupling area of the shower head.

The invention relates to a sanitary system having
a) a hand-held shower comprising:
   aa) a handle which can be connected to a shower hose;
   ab) a shower head carried by the handle;
   ac) at least one lighting means arranged in the shower head;
   and
   ad) at least one accumulator, by which the lighting means can be supplied with power and which is connected to connections accessible from outside for connection to a charging set;
      and
b) the charging set for charging the accumulator.

A sanitary system of this kind is described in WO 2005/118967 A1. Accumulator is understood to mean basically any rechargeable battery. To charge the accumulator, accommodated there in the handle, the hand-held shower in WO 2005/118967 A1 is plugged into a charging set mounted in the area of use of the hand-held shower. The charging set forms simultaneously the holder for the hand-held shower, in which the hand-held shower is normally accommodated when it is not in use. The charging set is coordinated in its visible design with the visible design of the hand-held shower, thus meeting the present-day demands of users as regards the external appearance of cooperating individual components of a sanitary system of the kind mentioned at the outset that they should always be seen to be matching.

The accumulator can only be charged by the user placing the hand-held shower as a whole in the charging station, which is situated in the wet area of the bathroom. The idea of electric current flowing in the wet area of a user's bathroom, namely the charging current for charging the accumulator, is, however, unpleasant to many users and is regarded as a source of danger.

There is therefore a need for a sanitary system of the kind mentioned at the outset in which the accumulator can be charged at a place remote from the wet area. At the same time, however, the observer is to be given an overall outward impression of uniformity of the individual components which reflects that they belong together in the system also when the accumulator is being charged.

This object is achieved in the case of a sanitary system of the kind mentioned at the outset in that
c) the accumulator is accommodated in the shower head and the shower head has, in a coupling region, the connections for connecting the accumulator to the charging set;
d) the shower head can be detached from the handle;
   and
e) the charging set comprises a receiving region, into which the shower head can be introduced by its coupling region for charging the accumulator and which has an inner contour complementary to the outer contour of the coupling region of the shower head.

With this design, the shower head having the accumulator can be simply separated from the handle of the hand-held shower by the user and taken to the charging set, which does not have to be situated in the wet area of the bathroom. The charging set in turn has a receiving region which is adapted to be complementary to the outer contour of the shower head and by which the shower head introduced into the charging set can be received with a form fit. Owing to this form fit when the shower head is inserted into the charging set, the observer is given an overall outward impression which shows that the components belong together in the system.

Advantageous developments of the invention are specified in the dependent claims.

An exemplary embodiment of the invention is explained in more detail below with the aid of the drawing, in which:

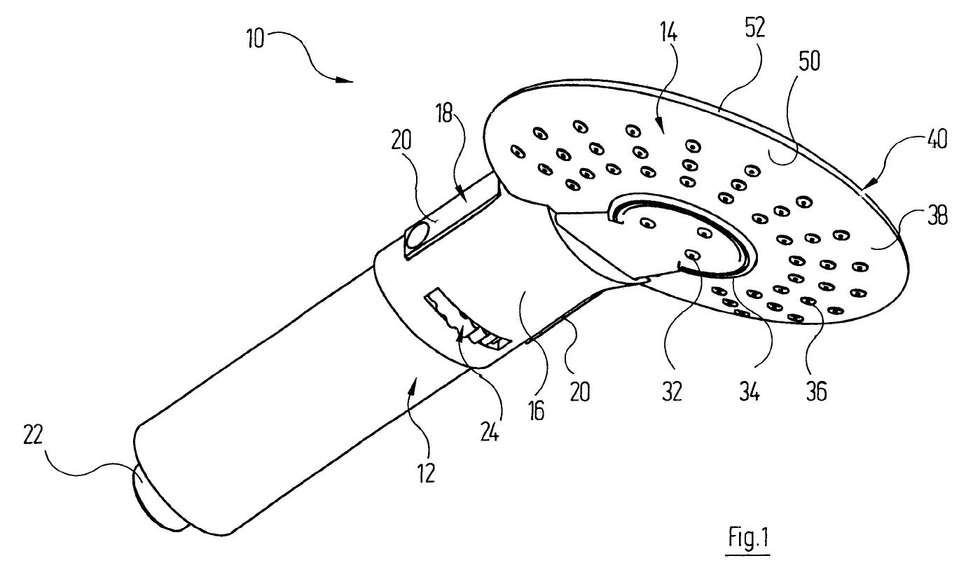

FIG. 1 shows an isometric illustration of a sanitary hand-held shower of a sanitary system, the shower comprising a detachable two-part shower head;

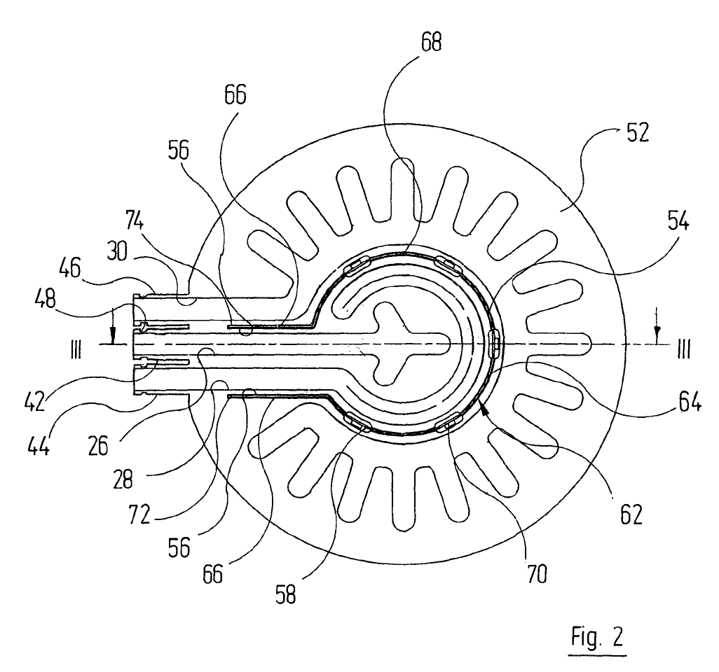

FIG. 2 shows a view from below of the, in FIG. 1, upper part of the two-part shower head;

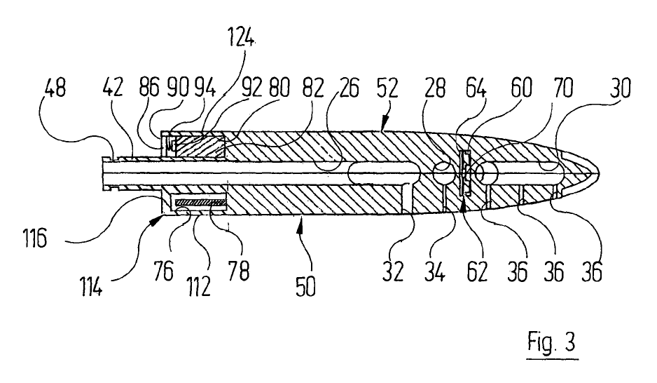

FIG. 3 shows a section through the shower head of FIG. 1 along the section line III-III in FIG. 2;

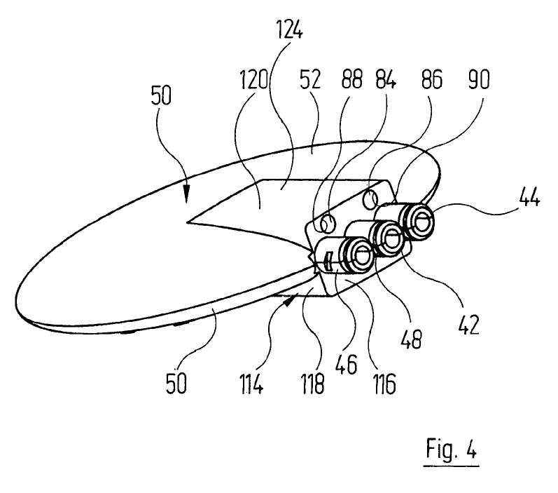

FIG. 4 shows an isometric illustration of the shower head of the hand-held shower of FIG. 1; and

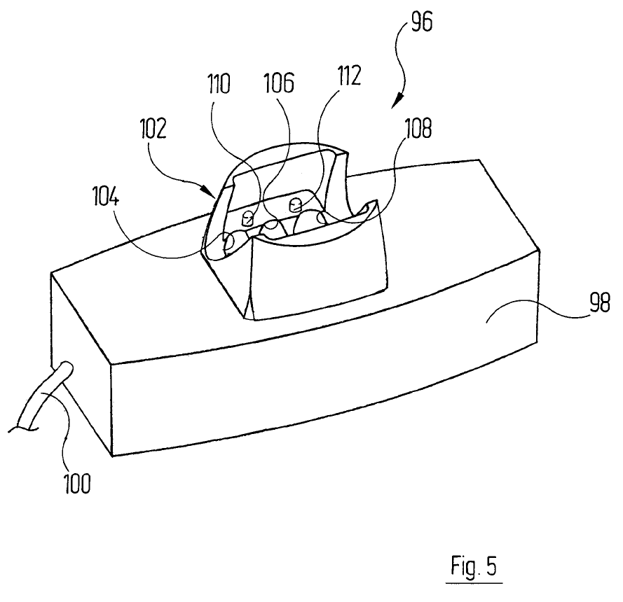

FIG. 5 shows a charging set of the sanitary system.

FIG. 1 shows a sanitary hand-held shower 10 comprising a handle 12 and a detachable shower head 14 which is separably connected to the handle 12. For the separable connection of the shower head 14 to the handle 12, there is provided in the end section 16 of the handle 12 adjacent to the shower head 14 a latching device 18, which is of no further interest here and of which two mutually opposite actuating rockers 20 can be seen in FIG. 1.

Provided at the end of the handle 12 opposite the shower head 14 is a connecting nipple 22, to which a shower hose can be fastened. Leading off from the connecting nipple 22 of the handle 12 is a water-guiding channel (not visible here) running inside the handle. Water can be guided by this channel by way of a switching device 24, which is likewise of no further relevance here and which can be actuated from outside by the user, via inner channels in the handle 12 to respectively one of three inner waterways 26, 28, 30 in the shower head 14, the course of which can be seen in FIG. 2. Each of the waterways 26, 28, 30 leads to in each case functionally different nozzles 32, 34 and 36, respectively, which serve as water outlet openings.

The nozzles 32, 34, 36 are provided in one side, formed in a known manner as a nozzle plate 38, of a two-part housing 40 of the shower head 14. The nozzles 32, 34, 36 form three groups of nozzles in the exemplary embodiment illustrated. Quite hard water jets which normally have a massage effect can be produced by the radially inner nozzles 32. These nozzles 32 are surrounded by a circular-arc-shaped nozzle 34, from which a torrent-like water jet can be emitted. The slotted nozzle 34 for its part is surrounded, in an annular region extending close to the peripheral edge of the housing 40 of the shower head 14, by a relatively large number of nozzles 36. A multiplicity of relatively soft shower jets which produce a particularly pleasant sensation emerge from these nozzles 36 during the operation of the hand-held shower.

To connect the inner waterways 26, 28, 30 in the shower head 14 to the corresponding channels (not shown here) in the handle 12, the waterways 26, 28, 30 open respectively into radially outer connecting pieces 42, 44, 46 which project beyond the peripheral edge of the housing 40, as can be seen in FIGS. 2, 3 and 4. The shower head 14 is seated with each of these connecting pieces 42, 44, 46 in respectively one receptacle, complementary thereto, in the end section 16 of the handle 12, the receptacle not being shown here in detail. For sealing with respect to this receptacle, each of the connecting pieces 42, 44, 46 has a peripheral groove 48, in which an O-ring can be seated. In each of FIGS. 2, 3 and 4, only the groove 48 of the connecting piece 38 is provided with a reference symbol.

The housing 40, of two-part design, of the shower head 14 comprises a lower shell 50 forming the nozzle plate 38 already mentioned, and an upper shell 52 opposite the lower shell, the shells being subsequently tightly bonded or welded to one another. The waterways 26, 28, 30 in the shower head 14 are formed in both shells 50, 52, whether already during a forming injection-moulding process or only subsequently by milling and/or drilling.

FIG. 2 shows a view of the upper shell 52 looking at its side facing inwards when the housing 40 is assembled. On this side, the upper shell 52 has a slot-shaped groove 54 on a circular arc which extends over an angle of about 315° and is arranged between the waterway 26 and the waterway 30. The mutually opposite ends of this circular-arc-shaped groove 54 face the connecting pieces 42, 44, 46. Starting from each of these ends of the groove 54, respectively one rectilinear slot-shaped groove 56 runs in the direction of the connecting pieces 42, 44, 46 and parallel to their longitudinal axis (cf. FIG. 2). The circular-arc-shaped groove 54 has, in an angular region of about 240°, five sections 58 which are uniformly spaced from one another and in which the groove 54 is radially enlarged (wider).

On the side, facing inwards when the housing 40 is assembled, of the shell 50 forming the nozzle plate 38, there is provided a groove corresponding to the groove 54, 56, 58, so that when the housing 40 of the shower head 14 is assembled a receiving space 60, which can be seen in the section in FIG. 3, is formed. This receiving space 60 serves for receiving a light emitting diode arrangement 62 which comprises a ribbon cable 64. The course of the ribbon cable 64 corresponds to that of the receiving space 60, i.e. the ribbon cable 64 has two mutually opposite rectilinear sections 66 and a circular-arc-shaped section 68. Five light emitting diodes 70 are mounted on the circular-arc-shaped section 68 of the ribbon cable 64 in such a way that respectively one light emitting diode 70 is seated in an enlarged section 58 of the receiving space 60 when the ribbon cable 64 with the light emitting diodes 70 is introduced into the receiving space 60.

The rectilinear sections 66 of the ribbon cable 64 form terminals 72, 74 of the light emitting diode arrangement 62. These terminals 72, 74 are connected to an electronics board 78, visible in FIG. 3, accommodated in a cutout 76 of the lower shell 50. The electronics boards 78 for its part is fed by an accumulator 82 mounted in a recess 80 in the opposite upper shell 52. The accumulator 82 can be charged, when the shower head 14 is detached, via two connections 84, 86 which are designed as contacts and provided at the end side of the shower head 14 assigned to the handle 12, as will be explained in more detail below.

Each of the connections 84, 86 of the shower head 14 is seated opposite the housing 40 fixedly in a respective opening 88 and 90 provided therein. The accumulator 82 has two pole terminals 92, each of which is connected via respectively one spring contact 94 to respectively one of the connections 84, 86. This can be seen in FIG. 3 using the example of the pole terminal 92 of the accumulator 82 which is connected to the connection 86 of the shower head 14.

During the operation of the hand-held shower 10, the light emitting diodes 70 of the light emitting diode arrangement 62 are supplied with current from the accumulator 82 via the ribbon cable 64, so that they emit light. The light emitting diodes 70 are oriented in such a way that they emit their light mainly radially outwards and this light radiates through the radially outer edge region of the housing 40. For this purpose, the two shells 50, 52 of the housing 40 are produced from a transparent material, for which preferably polycarbonates (PC) or polymethyl methacrylate (PMMA) are suitable.

FIG. 5 shows a charging set, denoted as a whole by the reference symbol 96, for charging the accumulator 82 in the shower head 14. The charging set comprises a free-standing housing 98, in which the customary electronic components, known per se, of a charging set are accommodated. Emerging from the housing 98 is a power cord 100, shown only partially in FIG. 5, by which the charging set 96 can be connected to the mains power supply.

On the upper side of the housing 98, the charging set 96 has a receiving region 102 for receiving the shower head 14. The receiving unit 102 is of fork-shaped design and has an inner contour which is complementary to the outer contour of a coupling region 114 of the shower head 14. As can be seen in FIG. 4, the coupling region 114 of the shower head 14 is provided on the side of the latter facing the handle 12 during the operation of the hand-held shower 10. It comprises a plane end face 116, which runs perpendicularly to the longitudinal axis of the connecting pieces 42, 44, 46 of the shower head 14, which for their part project beyond the end face 116. Seated in the end face 116 of the coupling region 114, at the level of the upper shell 52 of the shower head 14, are the connections 84, 86 for connecting the accumulator 82 to the charging set 96.

The coupling region 114 of the shower head 114 additionally comprises a lower and upper lateral surface 118, 120, which form respectively one section of the lower shell 50 and of the upper shell 52 of the housing 40 of the shower head 14 (cf. FIG. 4) and have respectively one region 122 and 124 running parallel to the parting plane of the shells 50, 52. Of these regions, only the region 124 can be seen in FIG. 4.

When the coupling region 114 of the shower head 14 is inserted into the charging set 96 or into the receiving unit 102 of the latter, the receiving unit 102 encompasses the shells 50, 52 of the housing 40 of the shower head 14. As indicated in FIG. 5, the receiving unit 102 of the charging set 96 comprises three blind bores 104, 106, 108 which are designed in a manner complementary to the connecting pieces 42, 44, 46 of the shower head 14 and receive these pieces when the shower head 14 is inserted into the charging set 96.

Adjacent to the blind bores 104, 106, 108 in the receiving unit 102 of the charging set 96, two spring-mounted contact pins 110, 112 are provided, corresponding to the positions of the connections 84, 86 of the shower head 14. Respectively one of the contact pins 110, 112 of the charging set 96 is connected to one of the connections 84, 86 of the shower head 14 when the latter is inserted into the charging set 96, with the result that the accumulator 82 in the shower head 14 is supplied with a charging current via the connections 84, 86 and the spring contacts 84.

The light emitting diodes 70 of the light emitting diode arrangement 62 can be activated during the charging process, for example via the electronics board 78 in the shower head 14, in such a way that during the charging process they produce a flashing light, which changes to a permanent light when the charging process is completed.

Altogether, the hand-held shower 10 and the charging set 96 form a coordinated sanitary system for charging a hand-held shower having components fed via an accumulator, both from a technical point of view, as regards the charging current for example, and in terms of the design.

1. A sanitary system having
a) a hand-held shower comprising:
aa) a handle which can be connected to a shower hose;
ab) a shower head carried by the handle;
ac) at least one lighting means arranged in the shower head;
and,
ad) an accumulator, by which the lighting means can be supplied with power and which is connected to connections accessible from outside for connection to a charging set;
and
the charging set for charging the accumulator wherein,
c) the accumulator is accommodated in the shower head and the shower head has, in a coupling region, the connections for connecting the accumulator to the charging set;
d) the shower head can be detached from the handle;
and,
e) the charging set comprises a receiving region, into which the shower head can be introduced by its coupling region for charging the accumulator and which has an inner contour complementary to the outer contour of the coupling region of the shower head.

2. The sanitary system claim 1, wherein the shower head has a two-part housing and the accumulator is seated in a recess in one of the housing parts.

3. The sanitary system of claim 1, wherein the accumulator is connected to the connections of the shower head via spring contacts.

4. The sanitary system of claim 1, wherein the lighting means comprises at least one light emitting diode.

5. The sanitary system of claim 1, wherein the lighting means comprises a ribbon cable, via which the lighting means is supplied with power by the accumulator.

6. The sanitary system of claim 5, wherein the ribbon cable carries light emitting diodes.

7. The sanitary system of claim 2, wherein the accumulator is connected to the connections of the shower head via spring contacts.

8. The sanitary system of claim 7, wherein the lighting means comprises at least one light emitting diode.

9. The sanitary system of claim 2, wherein the lighting means comprises at least one light emitting diode.

10. The sanitary system of claim 3, wherein the lighting means comprises at least one light emitting diode.

11. The sanitary system of claim 2, wherein the lighting means comprises a ribbon cable, via which the lighting means is supplied with power by the accumulator.

12. The sanitary system of claim 10, wherein the ribbon cable carries light emitting diodes.

13. The sanitary system of claim 3, wherein the lighting means comprises a ribbon cable, via which the lighting means is supplied with power by the accumulator.

14. The sanitary system of claim 13, wherein the ribbon cable carries light emitting diodes.

15. The sanitary system of claim 7, wherein the lighting means comprises a ribbon cable, via which the lighting means is supplied with power by the accumulator.

16. The sanitary system of claim 15, wherein the ribbon cable carries light emitting diodes.

17. The sanitary system of claim 4, wherein the lighting means comprises a ribbon cable, via which the lighting means is supplied with power by the accumulator.

18. The sanitary system of claim 17, wherein the ribbon cable carries light emitting diodes.

19. The sanitary system of claim 10, wherein the lighting means comprises a ribbon cable, via which the lighting means is supplied with power by the accumulator.

20. The sanitary system of claim 19, wherein the ribbon cable carries light emitting diodes.
